(19) United States
(12) Patent Application Publication
(10) Pub. No.: US 2022/0162758 A1
(43) Pub. Date: May 26, 2022

(54) A TURBOMACHINERY COMPONENT WITH A METALLIC COATING

(71) Applicant: NUOVO PIGNONE TECNOLOGIE - S.r.l, Florence (IT)

(72) Inventors: Giovanni PULCI, Roma (IT); Francesco MARRA, Roma (IT); Virgilio GENOVA, Roma (IT); Laura PAGLIA, Roma (IT); Alice PRANZETTI, Florence (IT); Marco ROMANELLI, Florence (IT); Domenico DI PIETRO, Florence (IT); Filippo CAPPUCCINI, Florence (IT)

(21) Appl. No.: 17/436,877

(22) PCT Filed: Mar. 6, 2020
(86) PCT No.: PCT/EP2020/025115

§ 371 Date: Sep. 7, 2021

(30) Foreign Application Priority Data
Mar. 11, 2019 (IT) 102019000003463

(51) Int. Cl. C23C 18/16; C23C 18/32; C09D 127/18; C09D 5/33

(52) U.S. Cl. CPC C23C 18/1662; C23C 18/1646; C08K 3/34; C09D 127/18; C09D 5/004; C23C 18/32

(57) ABSTRACT

A component for turbomachinery with anti-fouling properties and high resistance to erosion and corrosion.

### TECHNICAL FIELD

The subject-matter disclosed herein relates to a turbomachinery component comprising a substrate at least partially coated with at least one layer, deposited via chemical nickel plating (ENP), of a composition (C) comprising a mixture of nickel, at least one boron and phosphorus, and particles (P) comprising a ceramic material, a graphite-based material and/or a fluoropolymer.

### BACKGROUND ART

Fouling of turbomachinery equipment and turbomachine auxiliary systems, such as compressors, pumps, turbines, heat exchangers and the like, is a major drawback that leads to the deterioration of turbomachinery performance over time. Fouling is caused by the unwanted adherence of various organic and inorganic material to the metal substrate. Smoke, oil mists, carbonaceous residues and sea salts are common examples of such material.

Material adhesion and build-up is also influenced by oil or water mists that, combined with high temperature and pressure, promote hydrocarbon polymerization (i.e. cracked gas compression) and/or incrustation/deposition of mineral materials (i.e. on heat exchangers, turbines). As a result, this accumulation of material causes a number of different adverse effects such as the loss of thermal efficiencies of heat transfer equipment, high fluid pressure drops, loss of the aerodynamic performances due to roughness increase and eventually equipment breakage with loss of production due to unscheduled plant shutdowns.

Fouling can be partially prevented by appropriate systems of filtration of the gases entering the turbomachinery and can be removed, at least in part, by “on-line” washing the components with detergent agents. However, when on-line washing is no longer effective a more thoroughly removal needs to be performed, which involves the shutdown of the plant with a related increase in running costs and a decrease in productivity.

One way of trying to prevent this drawback without resorting to washing is the deposition, on the surfaces exposed to the deposit of fouling, of a layer of material that does not allow the adhesion of the contaminants to the metal substrate. Examples of such materials are organic/inorganic, fluorinated and non-fluorinated polymers, which, however, have some significant disadvantages. In fact, although the polymeric materials are effective against organic fouling, they are rapidly eroded away when inorganic particulate is also present in the fluid stream processed by the turbomachinery components and turbomachine auxiliaries systems. When the polymeric coating is removed by solid particle erosion (SPE), fouling is eventually formed on the uncoated substrate. Furthermore, the application of polymeric coatings requires line-of-sight to the surface being coated, similar to all other spraying processes. The major drawback of this application technique is the difficulty to coat inner surfaces of small diameter bores and other restricted access surfaces.

Besides solid particle erosion, deposits of polymeric materials on the turbomachinery components suffer from liquid droplet erosion, (LDE), due to the presence of water/solvent injection, which cause removal of conventional coatings and consequent erosion of the base material, thus leading to efficiency drop and premature end of service life. Polymeric coating removal (by solid particles or liquid erosion) can eventually trigger corrosion of the base material of components, due to exposure to contaminants present in the fluid stream.

Furthermore, the metallic material of the rotating components of the turbomachines tends to deform during service, in particular, when subject to high rotating speed and thermal gradient. To maintain the coating of the surface, the coating material should follow the deformation of the underlying substrate. Polymeric materials often undergo brittle fracture, especially at elevated velocities and under high strain rate. Moreover, they have a limited adhesion to the substrate that is only guaranteed by the surface preparation (grit blasting). This treatment, however, cannot always be performed on the substrate (i.e. superfinished or machined surfaces) As a result, the initially coated component may lose the coating layer, completely or partially, over time becoming exposed to fouling, erosion and corrosion attack.

The known coatings for turbo machinery are not capable of preventing fouling and, at the same time, resisting to corrosion and erosion.

### SUMMARY

In one aspect, the subject-matter disclosed herein is directed to a component for turbomachinery with anti-fouling properties and high resistance to erosion and corrosion. The component disclosed in the present allows to increase the efficiency and the service life of the turbomachinery and turbomachinery auxiliaries, while reducing the number of unwanted stops needed for fouling removal/cleaning.

In another aspect, the subject-matter disclosed herein is directed to a turbomachine comprising the component as described above. By way of non-limiting example, said component may be a part of a centrifugal compressor, a reciprocating compressor, a gas turbine, a centrifugal pump, a subsea component, a steam turbine or a turbomachine auxiliary system (which include but is not limited to flow pressure components, heat transfer component, evaluation equipment, drilling equipment, completions equipment, well intervention equipment, subsea equipment).

In another aspect, the subject-matter disclosed herein refers to the use of a coating comprising at least one layer of a composition (C) comprising a mixture, which comprises nickel, at least one of boron and phosphorus, and particles of size smaller than 1 micrometer, to prevent erosion, corrosion and fouling accumulation on the surface of a turbomachinery, where said use includes the application by chemical nickel plating (ENP) of said composition (C) to at least part of the surface of the turbomachinery components potentially subject to erosion, and/or corrosion and/or fouling.

### BRIEF DESCRIPTION OF THE DRAWINGS

A more complete appreciation of the disclosed embodiments of the disclosure and many of the attendant advantages thereof will be readily obtained as the same becomes better understood by reference to the following detailed description when considered in connection with the accompanying figures, wherein:

FIG. 1 shows scanning electron microscopy (SEM) images of a substrate coated with ENP compositions disclosed herein comprising, respectively, ceramic particles, PTFE particles and a mixture of ceramic and PTFE particles.

FIG. 2 shows the hardness values of an ENP coating without fillers and of ENP coatings containing the particles as disclosed herein.

FIGS. 3, 4 and 5 show, respectively, the EDS (Energy Dispersive X-ray Spectrometry) analysis of ENP+fluoropolymer particles, of ENP+inorganic particles and of ENP+fluoropolymer+inorganic particles.

FIG. 6 shows the results of an adhesion test conducted on a two ENP coatings as disclosed herein, containing fluoropolymer particles or inorganic particles.

In FIG. 7 are reported the SEM cross-section views of samples after exposure for 90 days in wet gas contaminated with chlorides (100 000 ppm Cl⁻) and carbon dioxide (CO₂) alone, at 10 bar (FIG. 7a), or 50 bar (FIG. 7b) or CO₂ (10 bar) and hydrogen sulfide (H₂S) (10 bar) mixture (FIG. 7c).

The graph in FIG. 8 is relative to the corrosion results in terms of thickness loss at 65° C. and 100 000 ppm of chlorides in solution saturated with CO₂ and H₂S at several partial pressures. The AVG value correspond to the thickness loss average while the 3s values correspond to the three-sigma interval, referring to the 99.7 confidence level.

FIG. 9 shows the results relative to the wettability envelope curve for a contact angle of 90°, thus representing the hydrophobicity threshold of the surface.

FIG. 10 shows the scheme of an in-house developed system to test the anti-fouling properties of the coated substrate according to the present invention.

The results of the solid erosion tests are shown in FIG. 11 and the results of the liquid droplet erosion tests are shown in FIGS. 12a and 12b (magnification of the lower area of the graph in FIG. 12a).

### DETAILED DESCRIPTION OF EMBODIMENTS

According to one aspect, the present subject matter is directed to a coated component for a turbo machinery that is advantageously capable of preventing fouling and, at the same time, resisting to corrosion and erosion. The turbomachinery and turbomachinery auxiliaries comprising the coated component as disclosed herein have increased efficiency and longer service life and the number of unwanted stops needed for removal/cleaning of fouling from the machinery is significantly reduced with respect to the known coated components.

According to one aspect, the subject-matter disclosed herein provides a component of a turbomachine comprising a substrate at least partially coated with at least one layer, deposited via electroless nickel plating (ENP), of a composition (C) comprising a mixture of nickel, particles (P) having an average size of less than 1 micrometer and at least one of boron and phosphorus, wherein said composition layer (C) has a thickness of 10 to 250 micrometers, preferably from 20 to 200 micrometers, more preferably from 50 to 100 micrometers, and said particles (P) comprise, or consist of, a ceramic material, a graphite-based material or a fluoropolymer.

The advantages of the turbomachine component disclosed herein are numerous and include the fact that the coating layer including composition (C) is highly resistant to corrosion, liquid impingement and solid erosion and, at the same time, minimizes, or fully avoids, fouling of the component. In addition, the coating layer including the composition (C) has excellent adherence to the substrate and capability to accommodate elastic or thermal strain of the substrate during operation, with the result that coverage by the anti-fouling coating is preserved throughout the service life of the component.

In a preferred embodiment, disclosed herein is a component wherein the composition (C) comprises particles of a ceramic material and particles of a fluoropolymer.

The single- or co-deposition of nano-particles along with the modulation of their concentration allows the synthesis of multi-functional purpose-made coatings, capable of withstanding corrosion, erosion and, at the same time, preventing fouling. Furthermore, the ENP is a no-line-of-sight coating, allowing an easier application to turbomachinery stationary and rotating components of substantially any geometries and size, obtaining a defectless coating and optimally protected surfaces, without altering the original surface finishing, including super-finished surfaces. Protection from fouling and resistance to corrosion and erosion of the component disclosed herewith are enhanced compared to the state of the art, which ultimately results in extended turbomachinery performances, avoidance of downtime, no coating coverage issues and decreased overall cost of operations.

In a preferred embodiment, disclosed herein is a component wherein, in the particles of composition (C), the ceramic material is one of silicon nitride, zirconium oxide, silicon dioxide, silicon carbide, boron nitride, tungsten carbide, boron carbide, aluminum oxide, aluminum nitride, titanium carbide (Tic), titanium oxide (TiO₂), hafnium carbide (HfC), zirconium carbide (ZrC), tantalum carbide (TaC) hafnium/tantalum carbide (TaxHfy-xCy), zirconium diboride ZrB₂, magnesium oxide MgO, yttrium oxide (Y₂O₃), vanadium oxide (VO₂), yttria partially stabilized zirconium oxide (YSZ), and mixtures thereof, the graphite-based material if one of MWCNT (multiwall carbon nanotubes), GNP (graphite nanoplates), graphene, graphite oxide and mixtures thereof and the fluoropolymer is one of polytetrafluoroethylene (PTFE), polyvinylidenfluoride (PVDF), polychlorotrifluoroethylene (PCTFE), perfluoroalkoxy (PFA), fluorinated ethylene propylene (FEP), polyethylene chlorotrifluoroethylene (ECTFE), ethylene tetrafluoro ethylene (ETFE) and mixtures thereof.

In a preferred embodiment, disclosed herein is a component wherein the composition (C) comprises from 5 to 35%, preferably from 10 to 30%, more preferably from 15 to 20%, by volume with respect to the total weight of (C), of particles (P).

In a preferred embodiment, disclosed herein is a component wherein the particles (P) in the composition (C) have average particle size less than 1 micron and preferably from 50 to 500 nanometers, more preferably from 100 to 350 nanometers or from 150 to 250 nanometers.

In a preferred embodiment, disclosed herein is a component wherein substrate is initially coated with a first layer of metallic material, preferably via electroless nickel plating or via electrodeposition, and the layer comprising composition (C) is deposited on said first layer, or wherein the substrate is coated directly with the coating composition (C).

In a preferred embodiment, disclosed herein is a component wherein between the substrate and the layer of a composition (C), deposited via chemical nickel plating, there is at least one other coating layer deposited via chemical nickel plating having a composition different from that of (C).

In a preferred embodiment, the present disclosure relates to a component of a centrifugal compressor, of a reciprocating compressor, of a gas turbine, of a centrifugal pump, of a subsea component, of a steam turbine, or a turbomachine auxiliary system, preferably a flow pressure component, heat transfer component, a piece of an evaluation equipment, of a drilling equipment, of a completions equipment, of a well intervention equipment or of a subsea equipment.

In an embodiment, the present disclosure relates to a turbomachine comprising the component as described above, which is preferably belonging to a centrifugal compressor, a reciprocating compressor, a gas turbine, a centrifugal pump, a submarine component or a steam turbine, a piece of evaluation equipment, of a drilling equipment, of a completions equipment, of a well intervention equipment, of a subsea equipment.

An embodiment of the present disclosure relates to the use of a coating comprising at least one layer of a composition (C) comprising a mixture comprising nickel, particles (P) having average dimensions of less than 1 micrometer and at least one of boron and phosphorus, wherein said composition layer (C) has a thickness of 10 to 250 micrometers, preferably from 20 to 200 micrometers, more preferably from 50 to 100 micrometers, and said particles (P) comprise, or consist of, a ceramic material, of a graphite-based material or a fluoropolymer to prevent erosion and fouling on the surface of a turbomachinery components, where said use includes application via chemical nickel plating (ENP) of said composition (C) to at least part of the surface of the turbomachinery potentially subjected to fouling and/or erosion.

Reference now will be made in detail to embodiments of the disclosure, examples of which is reported hereunder. Each example is provided by way of explanation of the disclosure. The following description and examples are not meant to limit the disclosure. In fact, it will be apparent to those skilled in the art that various modifications and variations can be made in the present disclosure without departing from the scope or spirit of the disclosure.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Unless otherwise indicated, within the context of the present disclosure the percentage quantities of a component in a mixture are to be referred to the weight of this component with respect to the total weight of the mixture.

Unless otherwise specified, within the context of the present disclosure the indication that a composition “comprises” one or more components or substances means that other components or substances may be present in addition to that, or those, specifically indicated.

Unless otherwise specified, within the scope of the present disclosure, a range of values indicated for an amount, for example the weight content of a component, includes the lower limit and the upper limit of the range. For example, if the weight or volume content of a component A is referred to as “from X to Y”, where X and Y are numerical values, A can be X or Y or any of the intermediate

In the context of the present disclosure, the term “electroless nickel plating” (ENP) indicates an autocatalytic process for depositing a nickel alloy from aqueous solutions onto a substrate without the use of electric current. Unlike electroplating, ENP does not depend on an external source of direct current to reduce nickel ions in the electrolyte to nickel metal on the substrate. ENP is a chemical process, wherein nickel ions in solution are reduced to nickel metal via chemical reduction. The most common reducing agent used is sodium hypophosphite or sodium borohydride. An even layer of a nickel-boron or a nickel-phosphorus (Ni—P) alloy is usually obtained. The metallurgical properties of the Ni—P alloy depend on the percentage of phosphorus, which can range from 2-5% (low phosphorus) to 11-14% (high phosphorus). Non-limiting examples of ENP and of processes for its deposition, directly on the substrate or on top of a first nickel layer applied by electroplating, are disclosed in WO 2013/153020 A2.

In the context of the present disclosure, the term “substrate” indicates the metallic or non-metallic material as the bulk of a turbomachinery component. As a non-limiting example, said material can be steel, such as carbon steel, low alloy steel, stainless steel, nickel-based alloys, cast iron, aluminum, babbiting material, graphene, mica, carbon nanotubes, silicon wafer, titanium, copper and carbon fibers, optionally coated with one or more layers of other materials such as a nickel-phosphorus layer, e.g. deposited via electroplating or electroless plating. Non-limiting examples of materials are disclosed in WO 2013/153020 A2 and in WO 2015/173311 A1.

In the context of the present disclosure, the term “fluoropolymer” indicates an organic polymeric material, wherein at least one fluorine atom is present. Non-limiting examples of such polymers are polytetrafluoroethylene (PTFE), polyvinylidene fluoride (PVDF), polyvinylfluoride (PVF), polychlorotrifluoroethylene (PCTFE), perfluoroalkoxy polymer (PFA), fluorinated ethylene-propylene (FEP), polyethylenetetrafluoroethylene (ETFE), polyethylenechlorotrifluoroethylene (ECTFE), and mixtures thereof.

In the context of the present disclosure, the size of the particles (P) are determined via any suitable method known to the person skilled in the art. As non-limiting example, the size of particles (P) can be determined via imaging analysis (e.g. with reference the article in Microscopy and Microanalysis 2012, 18(S2), 1244), laser light diffraction, scanning electron microscopy analysis, transmission electron microscopy, atomic force microscopy, field emission scanning transmission electron microscopy (FE/STEM) and equivalent methods, such as those listed in the “Overview of the Methods and Techniques of Measurement of Nanoparticles” by H. Stamm, Institute for Health and Consumer Protection Joint Research Centre, Ispra, presented at “nanotrust—Possible Health Effects of Manufactured Nanomaterials, Vienna, 24 Sep. 2009”. The particle size can be determined, without limitation, by Dynamic Light Scattering (DLS) according to DIN ISO 13321.

Reference throughout the specification to “one embodiment” or “an embodiment” or “some embodiments” means that the particular feature, structure or characteristic described in connection with an embodiment is included in at least one embodiment of the subject matter disclosed. Thus, the occurrence of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

When introducing elements of various embodiments, the articles “a”, “an”, “the”, and “said” are intended to mean that there are one or more of the elements. The terms “comprising”, “including”, and “having” are intended to be inclusive and mean that there may be additional elements other than the listed elements.

As non-limiting examples, coated samples were obtained starting from carbon steel, low alloy steel and stainless steel as substrate and using the following coating compositions (all weights are in grams and relative to 1000 ml of plating bath:

TABLE 1
Example of particles-filled ENP

| Component | Weight (g) |
|---|---|
| NiSO₄ | 12-25 |
| NaH₂PO₂ | 70-110 |
| C₆H₈O₇ | 6-9 |
| CH₃COONa | 15-20 |
| Inorganic particles | 2-20 |
| Fluoropolymer | 2-20 |
| Inorganic particles + | 4-40 |
| Fluoropolymer | |

In addition to the components reported in Table 1, at least one surfactant and one inhibitor may be present in the solution.

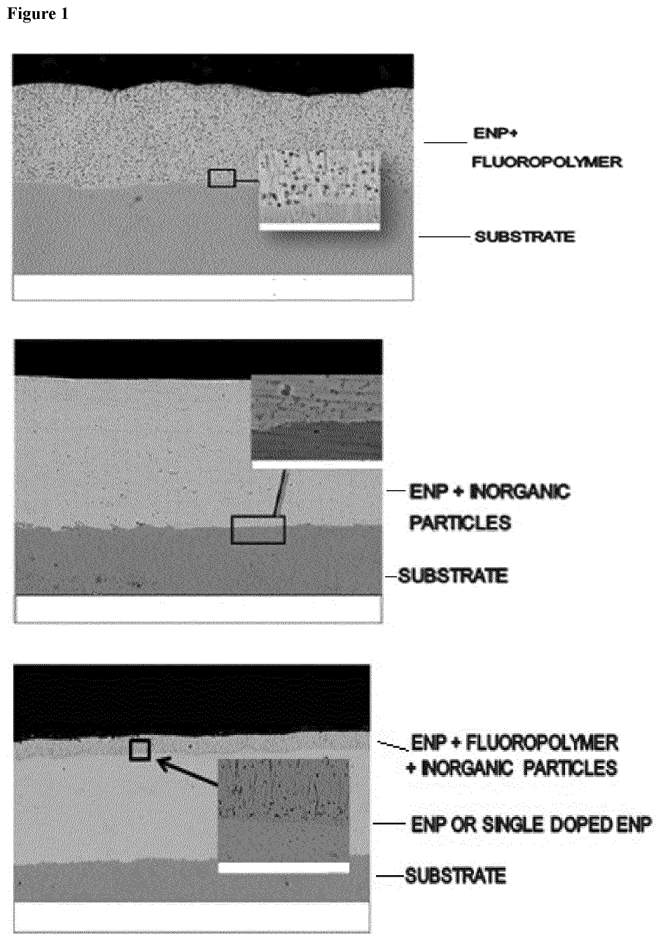

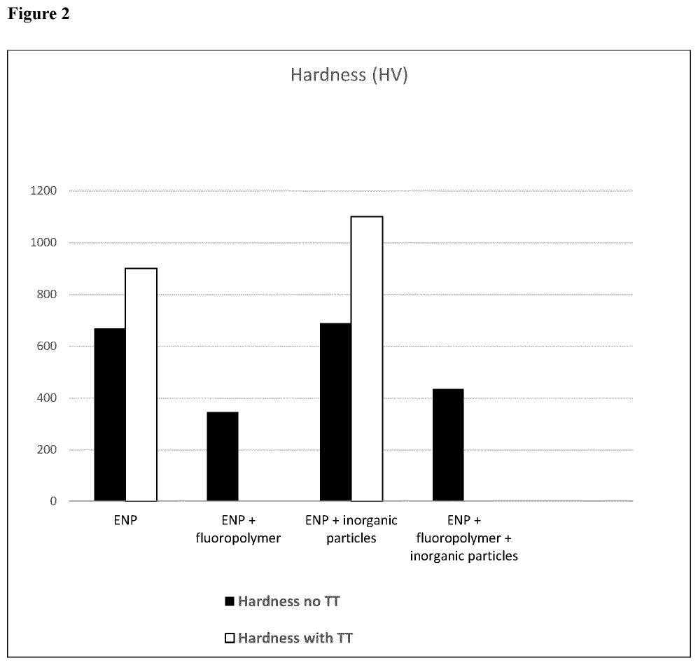

The scanning electron microscopy (SEM) images in FIG. 1 shows typical profiles of the substrate coated with ENP compositions disclosed herein comprising, respectively, ceramic particles, PTFE particles and a mixture of ceramic and PTFE particles.

The particles-filled ENP coatings (Table 1) have been characterized in terms of thickness homogeneity (thickness measurement performed with a thickness gauge as per ISO 2178), showing a thickness variation ≤5 μm. The absence of porosity was established by performing a Ferroxyl test, (ASTM A380/A380M), where no blue spots were observed on filter paper and by exposing the coated substrates to Salt Fog (ASTM B117) for 3000 hours with no rust detected.

The impact of the particle's presence in the ENP matrix on hardness has also been studied, with or without the coating heat treatment (HT, for more than one hour above 250° C.) and reported in FIG. 2 (ASTM E92).

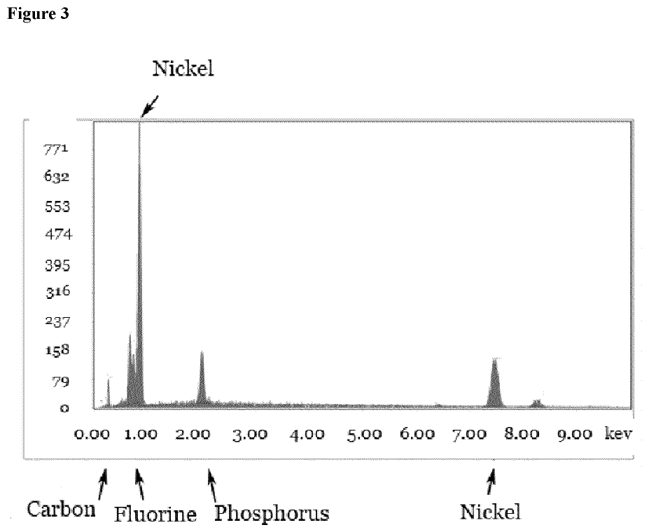

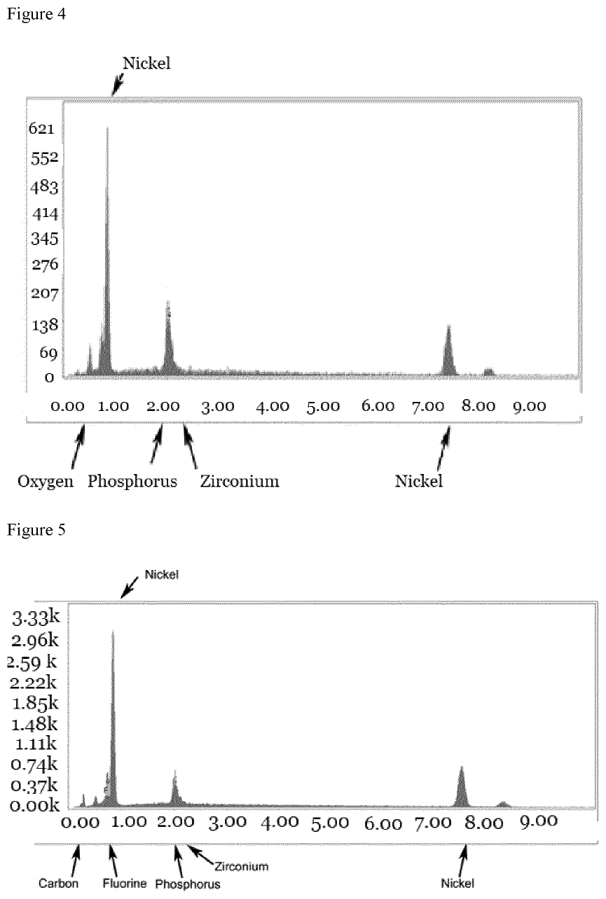

The chemical composition of the coatings has been characterized by EDS analysis, (FIG. 3, EDS of ENP+fluoropolymer particles; FIG. 4, EDS of ENP+inorganic particles; FIG. 5, EDS of ENP+fluoropolymer+inorganic particles)

The resistance of the coating to a mechanical impact has been tested according to ASTM B571 demonstrating no coating cracks observed at magnification 10×.

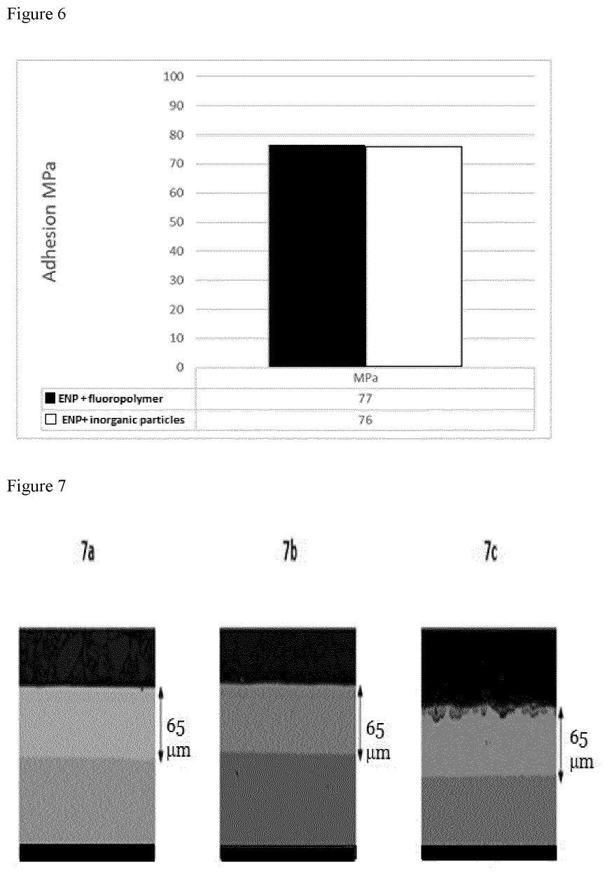

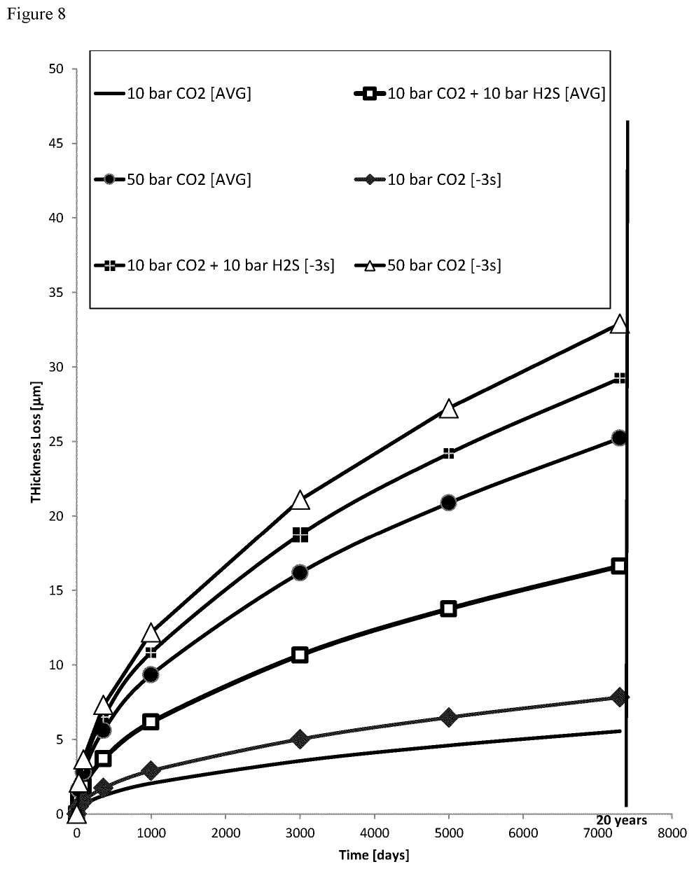

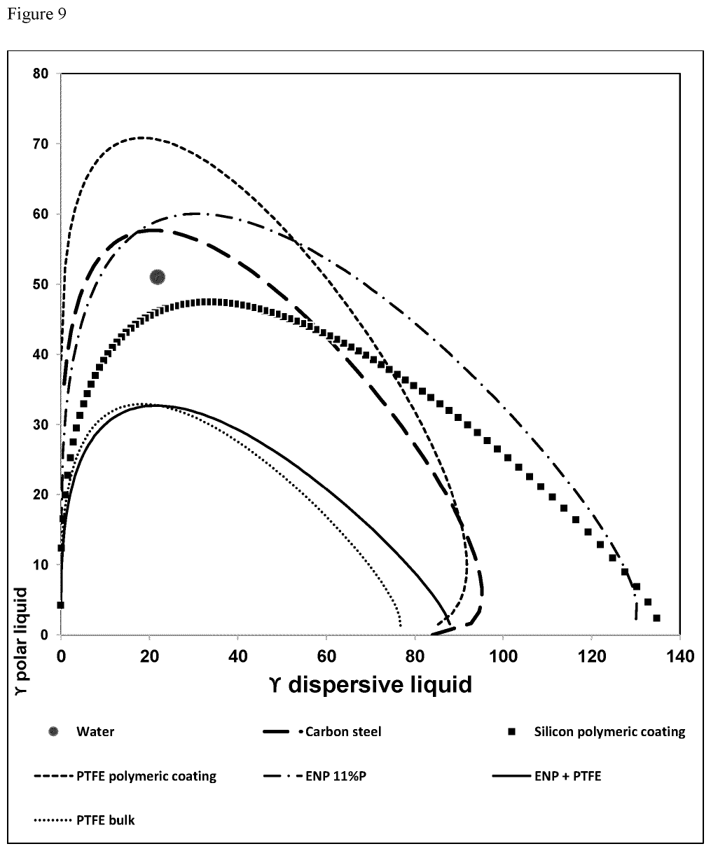

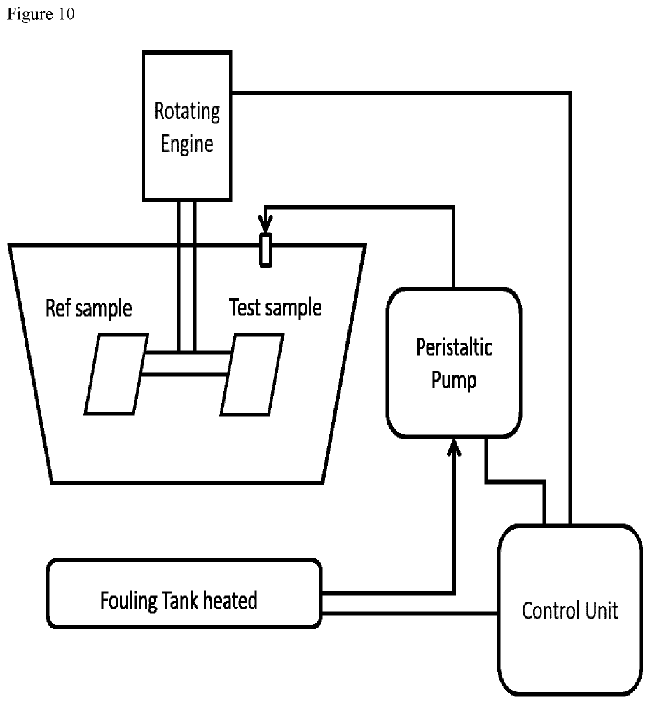

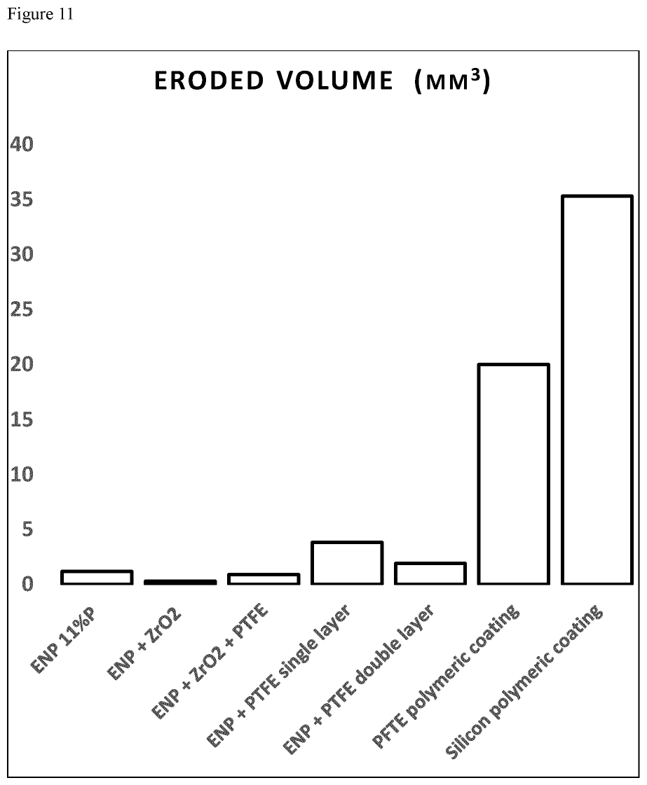

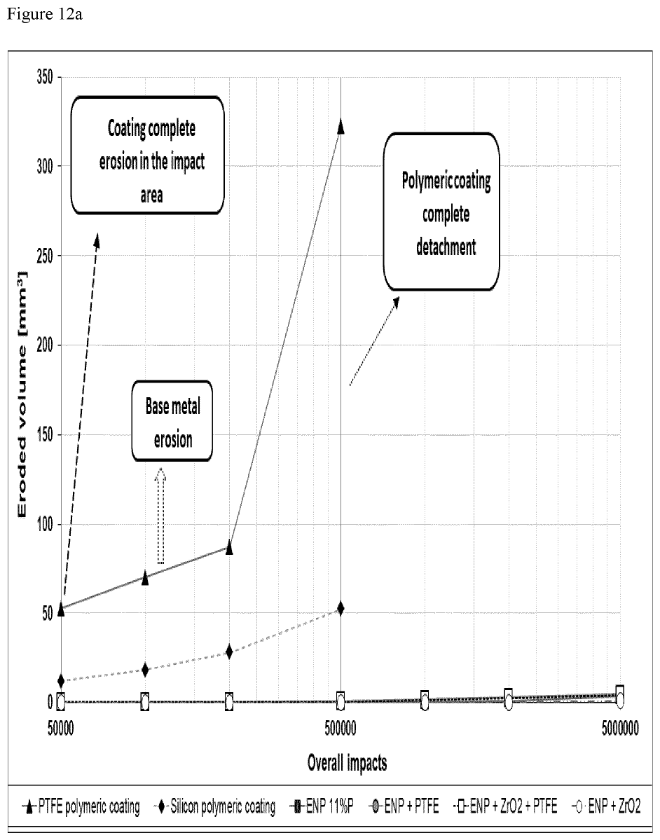

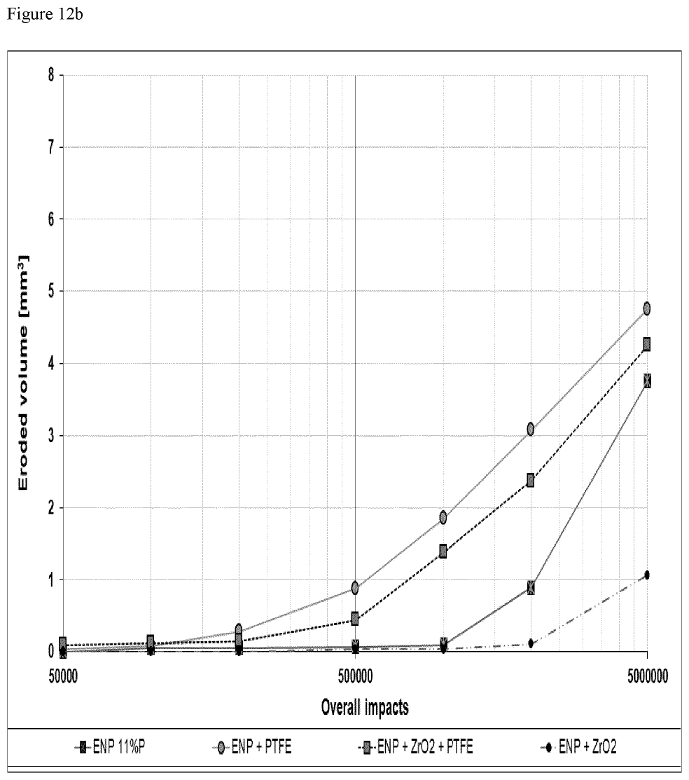

The adhesion of the coatings to the substrate has been evaluated by performing an adhesion test according to ASTM C633, using a tensile testing system. The results are reported in FIG. 6. The adhesion results are related to the glues detachment while no coating detachment has been observed.

Corrosion tests showed only slight corrosion attack on the coating surface with overall thickness maintained. FIG. 7 shows the SEM cross-section views of samples after exposure for 90 days in wet gas contaminated with chlorides (100 000 ppm Cl⁻) and CO₂ alone at 10 bar, (FIG. 7a), or 50 bar (FIG. 7b) or a mixture of CO₂ (10 bar) and H₂S (10 bar) (FIG. 7c). Only the sample exposed to H₂S has shown a reaction of ENP with the environment, leading to some localized corrosion. The picture shows the worst area recorded on the samples (6-7 microns of corrosion penetration). In environments containing CO₂ and chlorides the sample does not show any evidence of corrosion. This result indicates excellent corrosion resistance in the presence of salt and of salt and acid.

Corrosion results in terms of thickness loss at 65° C. and 100 000 ppm of chlorides in solution saturated with CO₂ and H₂S e at several partial pressures, are shown in FIG. 8 (AVG=average, 3s=three-sigma interval, corresponding to 99.7 confidence level) Corrosion rate showed a parabolic trend versus time. Based on this trend, a coating thickness loss of maximum 35 microns after 20 years of exposure (representative of machine service life) has been forecasted.

The wetting properties were determined using the sessile drop technique, using various types of coatings on carbon steel. The wetting properties were determined via a method comprising the steps of measuring the contact angles of liquids on the sampled surfaces and of calculating the polar part and the disperse part of the surface free energy of the solid surface and its wettability envelope curve.

The following materials were tested:

| Coating | Description | Substrate material |
|---|---|---|
| ENP-HP | Electroless Nickel | carbon steel |
| | Plating-10% | |
| | phosphorus | |
| ENP + nPTFE | Electroless Nickel | |
| | Plating-filler PTFE | |
| | (nano-particles) | |
| ENP + nZrO₂ | Electroless Nickel | |
| | Plating-filler | |
| | Zirconia | |
| | (nano-particles) | |
| Silicon polymeric | Commercially | |
| coatings | available coating | |
| PTFE polymeric | | |
| coatings | | |

The contact angles were determined for every sample with the following liquids: water, diiodomethane, ethyleneglycol and glycerol. At least 30 measurements were carried out for each sample so as to minimize the measurement errors. In the wetting properties test, the coating comprising a mixture of particles of ENP and fluoropolymers showed the best performance among the tested coatings. In particular, water contact angles as high as 120° have been observed. The contact angles for various materials and liquids are indicated hereunder.

| | Contact Angle (deg) | | | | Dispers. | Polar | Surface |
|---|---|---|---|---|---|---|---|
| | H₂O | Gly | Et-Gly | Dimeth. | Energy | Energy | Energy |
| Carbon steel | 84 | 96 | 70 | 69 | 21.0 | 5.8 | 26.8 |
| Silicon polymeric | 92 | 78 | 65 | 49 | 33.3 | 1.1 | 34.4 |
| coating | | | | | | | |
| PTFE polymeric | 77 | 88 | 72 | 71 | 18.4 | 9.7 | 28.1 |
| coating | | | | | | | |
| ENP + PTFE | 120 | 89 | 81 | 70 | 21.5 | 1.0 | 22.5 |
| ENP 11% P | 84 | 70 | 71 | 53 | 30.8 | 3.5 | 34.4 |
| PTFE | | | | | 18.4 | 1.6 | 20 |

Gly = glycerol;
Et-Gly = ethylene-glycol;
dimeth = diiodomethane,
H2O = water

Furthermore, by plotting the “wetting envelopes” by solving the Owens Wendt model for a contact angle of 90°, the coating comprising a mixture of particles of ENP and fluoropolymers showed the best liquid repellent performances.
The results relative to the wettability envelope curve of 90°, thus representing the hydrophobicity threshold of the surface, are reported in FIG. 9. The smaller the area, the lower the interaction of the solid surface with the liquids.

Anti-fouling properties were characterized using an in-house developed test. The samples coated with ENP+fluoropolymer, are mounted on a high-speed rotating holder and subjected to the centrifugal action of the machine while the fouler media, injected in the testing chamber, impacts at high speed against the samples surface. The scheme of the machine is shown in FIG. 10. The fouler composition is a mixture of asphalt (35% v/v) and lubricant (synthetic or mineral, e.g. Mobil 600 W) oil (65% v/v). The fouler media are heated through a heating plate and injected in the test chamber by a peristaltic pump. Samples are weighted before and after the tests. The fouling test results are referred as the percentage mass gain of the samples with respect to a reference sample (without coating) tested in the same test conditions. Considering 0 the weight gain of a sample with untreated surface, a sandblasted surface had a +43% mass gain, i.e. a significantly higher amount of fouling was formed, the ENP-coated surface had a +3.2% weight gain (i.e. fouling accumulated on the ENP-treated surface basically in the same amount as on the uncoated sample) and the sample coated with an ENP layer comprising fluoropolymer particles according to the present disclosure showed a significant reduction in fouling (−37% weight gain) with respect to the untreated sample.

All samples showed excellent liquid droplet erosion (LDE) and solid particle erosion (SPE) resistance. The former test has been carried out by exposing the samples to five million high speed impacts (250 m/s) with water droplets with a diameter of 400 μm. In the latter test the samples were grit blasted with grit having a particle size of 4-5 mm, using 200+10 kPa gravelometer air pressure, for two 10 second-long shots with impact distance 290+1 mm with impact angle 54+1° at 23° C., 50+5% relative humidity. The results of the solid particles erosion tests are reported in FIG. 11, the results in liquid droplet erosion tests are shown in FIGS. 12a and 12b. The impact resistance of the samples coated with composition (C) according to the present disclosure is superior to that of samples with a polymeric coating (PTFE or silicon, FIG. 12a) for both tests. Furthermore, the impact resistance is comparable with the impact resistance of ENP coating without filler particles in both tests (FIG. 11, FIG. 12b, magnification of the lower area of the graph in FIG. 12a).

1. A component of a turbomachine comprising a substrate at least partially coated with at least one layer, deposited via electroless nickel plating (ENP), of a composition (C) comprising a mixture of nickel, particles (P) having an average size of less than 1 micrometer and at least one of boron and phosphorus, wherein said composition layer (C) has a thickness of 10 to 250 micrometers and said particles (P) comprise, or consist of, a ceramic material, a graphite-based material or a fluoropolymer.

2. The component according to claim 1, wherein the composition (C) comprises particles of a ceramic material and particles of a fluoropolymer.

3. The component according to claim 1, wherein the ceramic material is one of silicon nitride, zirconium oxide, silicon dioxide, silicon carbide, boron nitride, tungsten carbide, boron carbide, aluminum oxide, aluminum nitride, titanium carbide (Tic), titanium oxide (TiO2), hafnium carbide (HfC), zirconium carbide (ZrC), tantalum carbide (TaC) hafnium/tantalum carbide (TaxHfy-xCy), zirconium diboride ZrB2, magnesium oxide MgO, yttrium oxide (Y2O3), vanadium oxide (VO2), yttria partially stabilized zirconium oxide (YSZ), and mixtures thereof, the graphite-based material if one of MWCNT (multiwall carbon nanotubes), GNP (graphite nanoplates), graphene, graphite oxide and mixtures thereof and the fluoropolymer is one of polytetrafluoroethylene (PTFE), polyvinylidenfluoride (PVDF), polychlorotrifluoroethylene (PCTFE), perfluoroalkoxy (PFA), fluorinated ethylene propylene (FEP), polyethylene chlorotrifluoroethylene (ECTFE), ethylene tetrafluoro ethylene (ETFE) and mixtures thereof.

4. The component according to claim 1, wherein the composition (C) comprises from 5 to 35%, by weight with respect to the total weight of (C), of particles (P).

5. The component according to claim 1, in which the particles (P) have average particle size from 50 to 500 nanometers.

6. The component according to claim 1, comprising at least one coating layer, deposited via chemical nickel plating and having a composition different from that of (C), between the substrate and the layer of a composition (C) deposited via chemical nickel plating.

7. The component according to claim 1, which is a component of a centrifugal compressor, of a reciprocating compressor, of a gas turbine, of a centrifugal pump, of a subsea component, of a steam turbine, or a turbomachine auxiliary system, preferably a flow pressure component, a heat transfer component, a piece of an evaluation equipment, of a drilling equipment, of a completions equipment, of a well intervention equipment or of a subsea equipment.

8. A turbomachine comprising the component according to claim 1, which is preferably a centrifugal compressor, a reciprocating compressor, a gas turbine, a centrifugal pump, a submarine component or a steam turbine, a piece of evaluation equipment, of a drilling equipment, of a completions equipment, of a well intervention equipment or of a sub sea equipment.

9. Use of a coating comprising at least one layer of a composition (C) comprising a mixture comprising nickel, particles (P) having average dimensions of less than 1 micrometer and at least one of boron and phosphorus, wherein said composition layer (C) has a thickness of 10 to 250 micrometers and said particles (P) comprise, or consist of, a ceramic material, of a graphite-based material or a fluoropolymer to prevent wear and encrustations on the surface of a turbomachinery, where said use includes application via chemical nickel plating (ENP) of said composition (C) to at least part of the surface of the turbomachinery potentially subjected to wear and/or fouling.
